(19) United States
(12) Patent Application Publication
(10) Pub. No.: US 2026/0219143 A1
(43) Pub. Date: Jul. 30, 2026

(54) APPARATUS AND SYSTEM FOR MICROFLUIDIC TISSUE STAINING

(71) Applicant: Joseph Huang, MONROE, NJ (US)

(72) Inventor: Joseph Huang, MONROE, NJ (US)

(21) Appl. No.: 19/531,935

(22) Filed: Feb. 6, 2026

(51) Int. Cl. G01N 1/31; G02B 21/36

(52) U.S. Cl. CPC G01N 1/312; G02B 21/362

(57) ABSTRACT

An apparatus and system for staining tissue samples on slides are disclosed. The apparatus includes a support cartridge, a rotatable cover, and a sealing structure that form a reaction chamber over a tissue section when closed against a slide. Reagents are delivered through internal channels via inlet, outlet, and ventilation ports to enable controlled flow. Temperature and drainage structures may improve staining reliability. Multiple apparatuses may be arranged on a support platform for parallel staining using independent protocols. A transparent layer serves as an optical window, allowing observation or imaging of stained tissue sections without removing the slide.

This application claims priority to U.S. Provisional Patent Application No. 63/860,874, filed on Aug. 9, 2025, the entire contents of which are incorporated herein by reference.

### BACKGROUND

### Field of the Invention

The present invention relates generally to tissue staining systems for pathological analysis, and more particularly to microfluidic apparatuses and systems for automated staining of tissue samples on microscope slides, including parallel staining configurations and integrated imaging suitable for clinical, research, and intraoperative applications.

### Description of Related Art

Histopathological evaluation relies on the preparation and staining of paraffin or frozen tissue sections mounted on microscope slides. Conventional staining methods, including manual staining and immersion-based approaches, often require large reagent volumes, are time-consuming, and can introduce variability due to inconsistent fluid exposure, timing differences, and operator-dependent handling.

Automated slide stainers used in clinical laboratories are generally designed for high-throughput batch processing. Such systems are commonly bulky, expensive, and optimized for standardized kits and large reagent containers, which are poorly suited to applications requiring rapid turnaround, small reagent volumes, customized protocols, or point-of-care deployment, including intraoperative consultations.

Microfluidic approaches to tissue staining can reduce reagent consumption and improve uniformity by confining reagents to a defined chamber over a tissue section. However, existing microfluidic staining devices may lack robust, repeatable sealing; practical provisions for ventilation and drainage; temperature control and stabilization; scalable parallel operation; and convenient integration with optical observation or imaging workflows.

Accordingly, there remains a need for compact, reliable, and versatile apparatuses capable of performing controlled microfluidic tissue staining with reduced reagent usage, improved reproducibility, optional thermal regulation, and scalability to parallel and dual-staining workflows, with optional integration to imaging for efficient pathological evaluation.

### BRIEF SUMMARY OF THE INVENTION

The present invention provides an apparatus and system for microfluidic staining of tissue samples disposed on microscope slides. In one aspect, the invention provides a staining apparatus comprising a support cartridge, a rotatable cover, and a sealing structure that cooperatively define a microfluidic reaction chamber over a tissue section when the rotatable cover is closed against a microscope slide.

In certain embodiments, the apparatus includes an inlet port and an outlet port in fluid communication with the microfluidic reaction chamber, together with internal microfluidic channels configured to deliver staining reagents in a controlled manner across the tissue section. A ventilation port may be provided to facilitate air displacement during reagent introduction, thereby improving uniform reagent coverage and reducing bubble formation within the reaction chamber.

In certain embodiments, the apparatus further includes drainage structures, such as a drain port and an associated slot, configured to collect and remove excess or leaked fluids external to the microfluidic reaction chamber, thereby improving operational reliability and reducing contamination of surrounding components.

In certain embodiments, the microfluidic reaction chamber defines a substantially planar flow region and has a small internal volume, for example, less than approximately 500 microliters. The chamber volume may be adjustable, such as by varying a height of the sealing structure relative to a support surface of the support cartridge, thereby accommodating different staining protocols, reagent volumes, and tissue formats.

In certain embodiments, temperature control is provided by cooling tubings embedded within the support cartridge and a thermal control element, such as a heater and a temperature sensor, configured to regulate and stabilize temperature within the microfluidic reaction chamber for temperature-sensitive staining procedures.

In further embodiments, multiple staining apparatuses may be arranged on a common support platform to define a plurality of microfluidic reaction chambers operable independently. In a dual-apparatus configuration, two staining apparatuses may be mounted side-by-side to perform different staining protocols concurrently, such as a histochemical stain and an immunohistochemical stain, thereby enabling rapid workflows, including intraoperative pathological evaluation.

In additional embodiments, a transparent elastic layer mounted in the rotatable cover serves as an optical window that allows observation or imaging of stained tissue sections without removing the microscope slide from the staining apparatus. The staining apparatus may be used in combination with an imaging module comprising an optical lens and an image sensor to capture images for digital pathology and for local or remote review.

In certain embodiments, the invention provides a staining system comprising a plurality of microfluidic staining apparatuses mounted on a common support platform in an angular arrangement that facilitates optical imaging. Each staining apparatus includes a rotatable cover having a transparent elastic layer that serves as an optical window positioned above a stained tissue section on a microscope slide. The staining apparatuses are arranged at selected angular positions relative to one another such that a camera, comprising an optical lens and an image sensor and rotatable about a central point relative to the support platform, may be selectively aligned with individual staining apparatuses during rotation.

This configuration allows the camera to aim through the optical window of each staining apparatus to capture images of stained tissue sections without removing the microscope slides from the apparatuses. The angular arrangement is not limited to two staining apparatuses and may include three, four, or more staining apparatuses positioned around the support platform based on optical geometry, mechanical layout, or system footprint considerations, while maintaining unobstructed optical paths and repeatable alignment during camera rotation.

These and other aspects, features, and advantages of the invention will be apparent from the following detailed description and the accompanying drawings.

### BRIEF DESCRIPTION OF THE DRAWINGS

The accompanying drawings illustrate embodiments of the invention and, together with the description, explain the principles of the invention. The drawings are not to scale, and like reference numerals indicate like elements throughout.

FIG. 1 is a perspective view of a microfluidic staining apparatus showing a support cartridge, a rotatable cover, a sealing structure, fluid ports, a ventilation port, a drain structure, and associated components for forming a microfluidic reaction chamber.

FIG. 2 is a perspective view of the apparatus of FIG. 1 in an open configuration, illustrating the insertion and removal of a microscope slide and the rotational movement of the rotatable cover about a hinge.

FIG. 3 is a front view of the apparatus of FIG. 1 in a closed configuration of the rotatable cover.

FIG. 4 is a sectional view of the apparatus of FIG. 3 taken along line A-A′, showing a microfluidic reaction chamber formed between the support cartridge, sealing ring, and microscope slide, and illustrating a planar flow region across a tissue section and drainage structures.

FIG. 5 is a detailed sectional view of a portion of FIG. 4 in area B, further defining a microfluidic reaction chamber and illustrating internal microfluidic channels, fluid ports, ventilation, and temperature-control components embedded within the support cartridge.

FIG. 6 is a perspective view of a multiple-apparatus staining system comprising a plurality of microfluidic staining apparatuses mounted on a common support platform, illustrating parallel staining capability and numerical indicators associated with individual staining positions.

FIG. 7 is a perspective view of a dual-apparatus staining system comprising two staining apparatuses mounted side-by-side on a support platform, each having independent interfaces and components for performing two staining processes.

FIG. 8 is a top view of the dual-apparatus staining system of FIG. 6, illustrating the arrangements of the two staining apparatuses mounted side-by-side at a selected angle on the support platform.

FIG. 9 is a rear view of the dual-apparatus staining system of FIG. 6, showing the staining apparatuses mounted on the support platform and provided with fluid ports, ventilation structures, and temperature-control components for each staining apparatus.

FIG. 10 is a perspective view of the dual-apparatus staining system of FIG. 6 integrated with an integration of an imaging module, illustrating imaging stained tissue sections while the microscope slide remains within the staining apparatus.

FIG. 11 is a schematic top view illustrating a digital pathology configuration in which an imaging module is rotatable about a center point to selectively image multiple staining apparatuses arranged around the center point.

### DETAILED DESCRIPTION OF THE INVENTION

The present invention provides apparatuses and systems for microfluidic staining of tissue samples mounted on microscope slides. The embodiments described herein are illustrative and are not intended to limit the scope of the invention.

For purposes of clarity, reference numerals are used consistently to refer to corresponding elements shown in the drawings. Unless otherwise indicated, features described with respect to one embodiment may be combined with features of other embodiments.

### Microfluidic Staining Apparatus

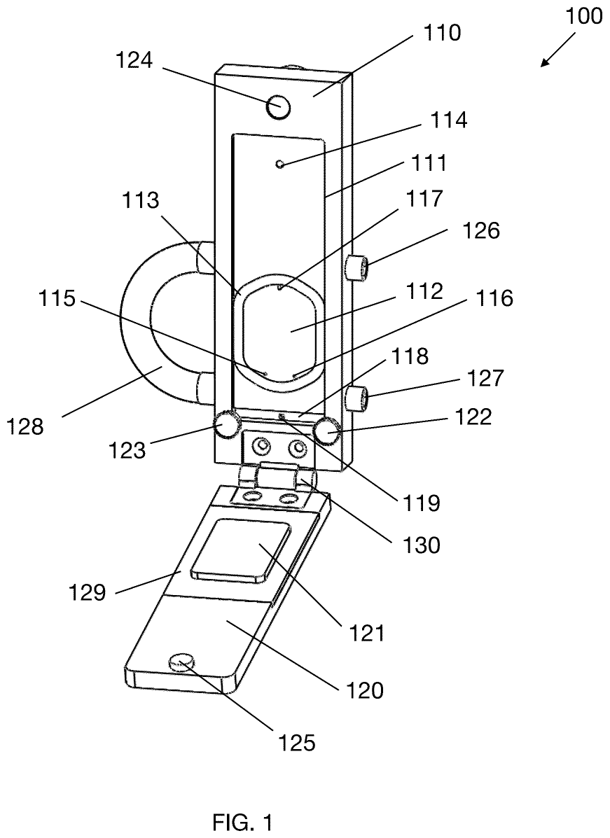

Referring to FIGS. 1-3, a staining apparatus (100) comprises a support cartridge (110) and a rotatable cover (120) coupled to the support cartridge (110) by a hinge (130). The support cartridge (110) includes a recess (111) configured to receive and position a microscope slide (140) carrying a tissue section (141).

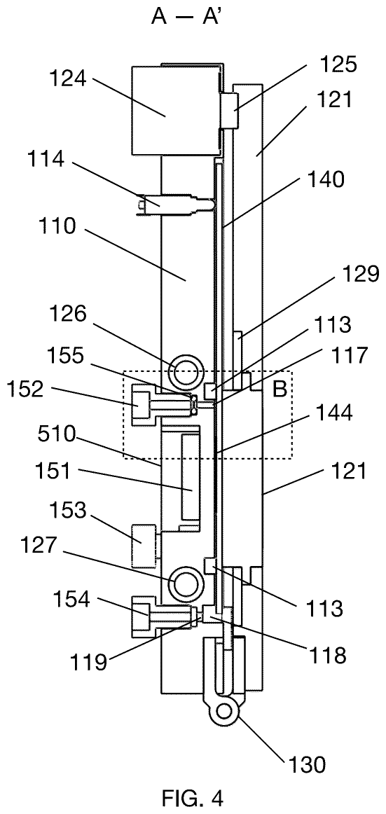

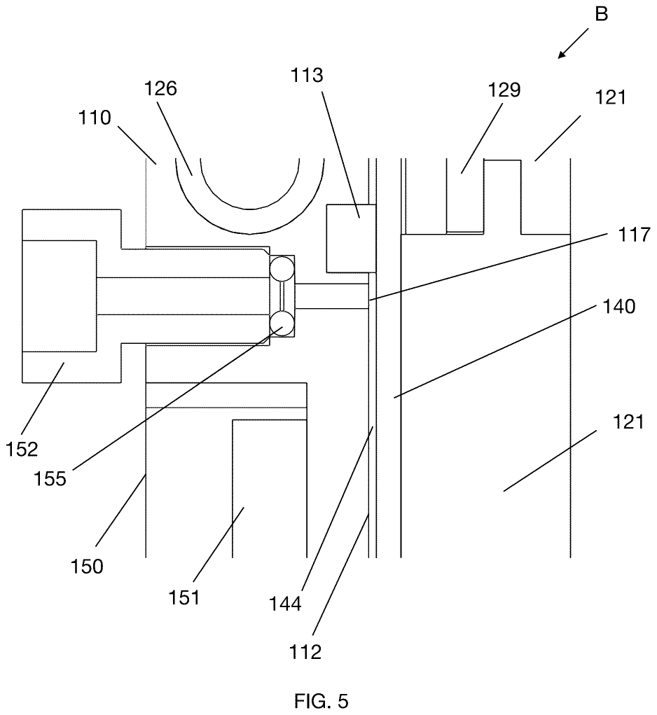

A sealing ring (113) is positioned in or on the support cartridge (110). When the rotatable cover (120) is rotated to a closed position, a surface (112) of the support cartridge (110), the sealing ring (113), and the microscope slide (140) cooperatively define a microfluidic reaction chamber (144) positioned over the tissue section (141), as further illustrated in the sectional and detailed views of FIGS. 4 and 5.

In certain embodiments, a transparent elastic layer (121) is mounted within the rotatable cover (120) by a clamp plate (129). The transparent elastic layer (121) transmits compressive force to the microscope slide (140) and the sealing ring (113) to promote sealing, while also serving as an optical window for observing or imaging the stained tissue section (141).

### Mechanical Locking and Compression Control

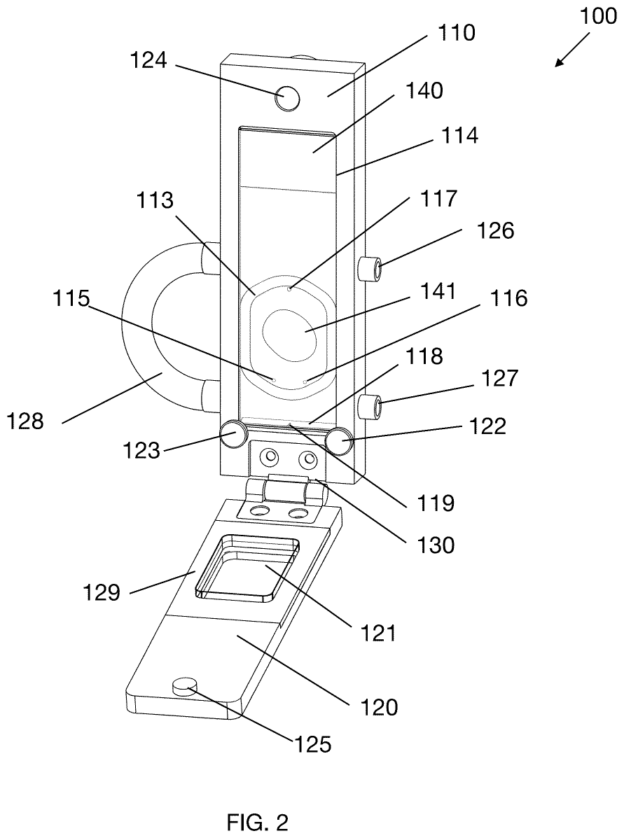

Referring to FIGS. 2 and 4, the rotatable cover (120) is pivotable between an open position that allows insertion and removal of the microscope slide (140) and a closed position that forms the microfluidic reaction chamber (144). In certain embodiments, an electromagnetic locking mechanism (124) and a pad (125) secure the rotatable cover (120) in the closed position, thereby maintaining a controlled and substantially uniform compressive force across the sealing interface during staining.

### Fluid Ports, Ventilation, and Reagent Delivery

Referring to FIGS. 1-5, the apparatus (100) includes an inlet port (115) and an outlet port (116) in fluid communication with the microfluidic reaction chamber (144). A fluid delivery connector (153) may couple the inlet port (115) to an external syringe, pump, or pressurized reservoir to deliver staining reagents. A corresponding connector may couple the outlet port (116) to a collection syringe, pump, or vacuum source.

In certain embodiments, a ventilation port (117) is positioned at an upper region of the microfluidic reaction chamber (144) to facilitate air displacement during reagent introduction, thereby improving filling uniformity and reducing trapped air.

Referring to FIG. 5, internal microfluidic channels formed within the support cartridge (110) connect the inlet port (115), outlet port (116), and ventilation port (117) to the microfluidic reaction chamber (144) and to one or more external connectors (152). Sealing elements such as O-rings (155) may be provided at connector interfaces. Channel diameters may range from approximately 0.2 mm to 2.0 mm to enable controlled flow with low dead volume.

### Drainage, Chamber Geometry, and Volume Control

Referring to FIGS. 1 and 5, one or more drain ports (119) may be provided and connected to slots (118) configured to collect and remove leaked or excess fluid from regions outside the microfluidic reaction chamber (144).

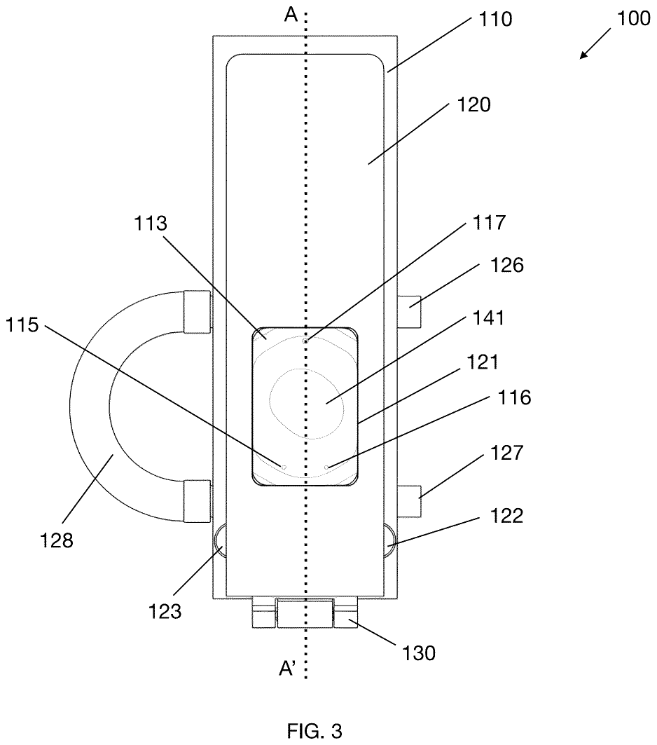

Referring to FIGS. 3 and 5, the microfluidic reaction chamber (144) defines a substantially planar flow region across the tissue section (141). In certain embodiments, the chamber volume is less than approximately 500 microliters and may be adjusted by varying the height of the sealing ring (113) relative to the surface (112).

### Temperature Control

Referring to FIGS. 1, 4, and 5, the apparatus (100) may include a temperature control assembly. Cooling tubings (126, 127, 128) may be embedded within the support cartridge (110). A thermal control element (151), such as an electrically powered heater and a temperature sensor, may regulate temperature within the microfluidic reaction chamber (144).

### Slide Positioning and Detection

Referring to FIGS. 2 and 4, positioning pads (122, 123) may be disposed within the recess (111) to support the microscope slide (140) in a predetermined position. When the rotatable cover (120) is closed, the microscope slide (140) actuates a snap switch (114) that generates a control signal indicating proper slide placement.

### Multiple-Apparatus Parallel Staining System

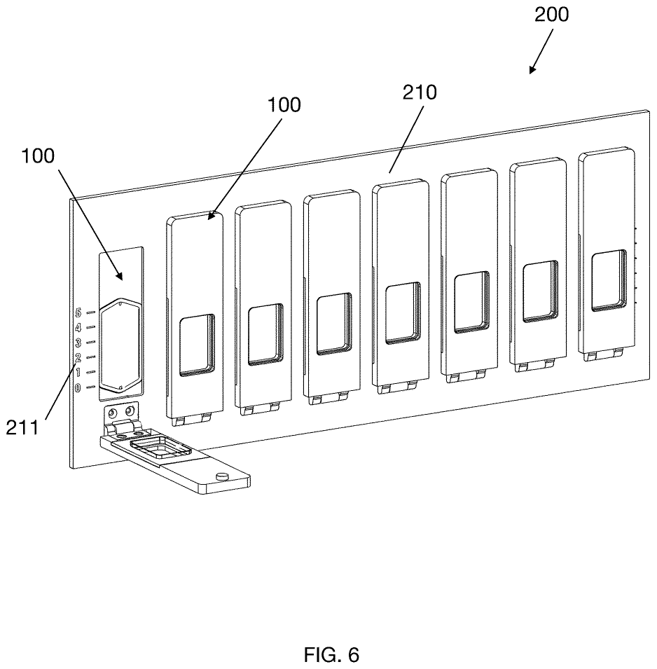

Referring to FIG. 6, multiple staining apparatuses (100) may be mounted on a common support platform (210) to define a multiple-apparatus staining system (200). Each staining apparatus independently defines a corresponding microfluidic reaction chamber (144), enabling parallel staining of multiple microscope slides (140) with independent protocols, reagents, and timing.

### Numeric Volume-Selection Feature

Referring to FIG. 6, in certain embodiments, the staining apparatus (100) includes a numeric volume-selection feature comprising a plurality of numerical indicators (211) disposed on or adjacent to a surface of the support cartridge (110). The numerical indicators (211) are positioned to correspond to respective tissue positions (141) on a microscope slide (140) received within the apparatus.

Each numerical indicator (211) represents a predefined reagent volume associated with the corresponding tissue position (141). During preparation or operation, a user or system operator selects a desired numerical indicator, thereby defining a reagent volume to be delivered into the microfluidic reaction chamber (144) associated with that tissue position. The selected numerical indicator may correspond to discrete reagent volumes suitable for different tissue sizes, thicknesses, or staining protocols.

In certain embodiments, the numerical indicators (211) comprise a sequence of integers, for example, from 0 to 5, representing increasing reagent volumes. The numerical indicators may be visually marked, embossed, printed, or otherwise formed on the support cartridge (110), and may be aligned with corresponding tissue placement regions on the microscope slide (140) to facilitate intuitive and repeatable volume selection.

The numeric volume-selection feature enables reduction of reagent waste and improved staining consistency by allowing reagent delivery volumes to be matched to the size or location of the tissue section (141) without requiring changes to hardware components or microfluidic channel geometry. In certain embodiments, the selected numerical indicator is used to control reagent delivery by a fluid delivery interface coupled to the inlet port (115).

While the numerical indicators (211) are illustrated as being manually selectable, the volume-selection feature is not limited to manual operation. In alternative embodiments, the numerical indicators may be read by a sensing element, encoder, or control interface to automatically define reagent delivery volume, without departing from the scope of the invention.

### Dual-Apparatus Side-by-Side Staining System

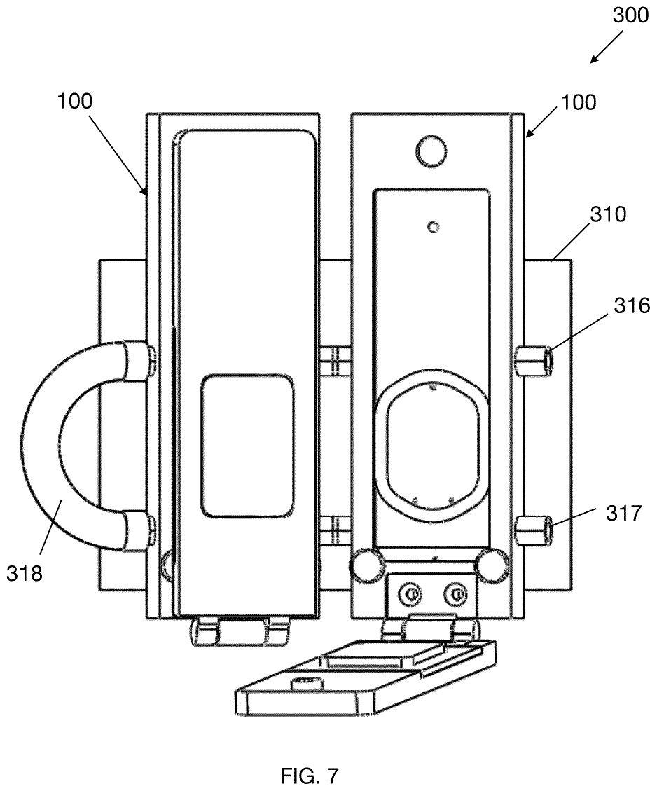

Referring to FIG. 7, a dual-apparatus staining system (300) comprises two staining apparatuses (100) mounted side-by-side on a common support platform (310). Each staining apparatus independently defines its own microfluidic reaction chamber (144) and fluid interfaces, enabling concurrent execution of different staining protocols.

The support platform (310) provides positional stability and alignment for the two staining apparatuses while allowing them to remain functionally independent, each having its own reagent paths, reaction chamber, and control interfaces.

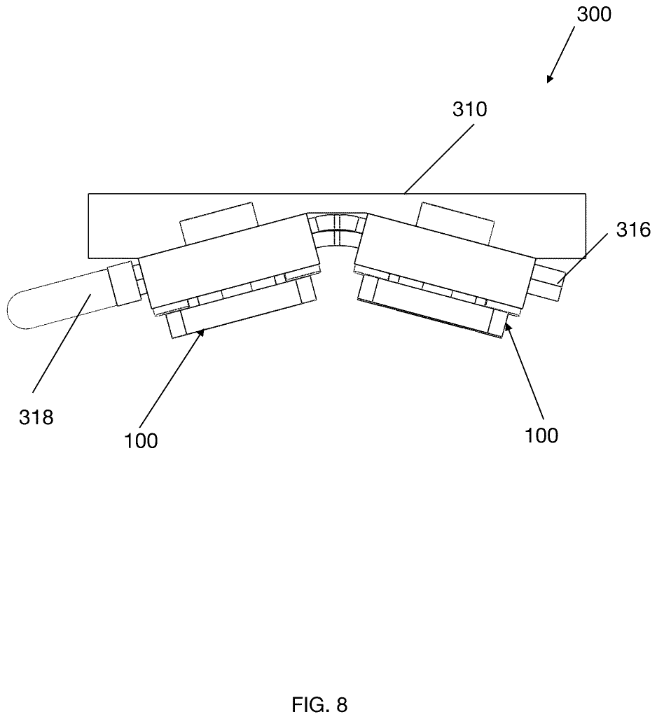

Referring to FIG. 8, a top view of the dual-apparatus staining system illustrates the relative positioning of the two staining apparatuses on the support platform (310). The configuration accommodates shared or independent auxiliary components, including thermal management elements, while maintaining a compact system footprint suitable for laboratory, clinical, or intraoperative environments.

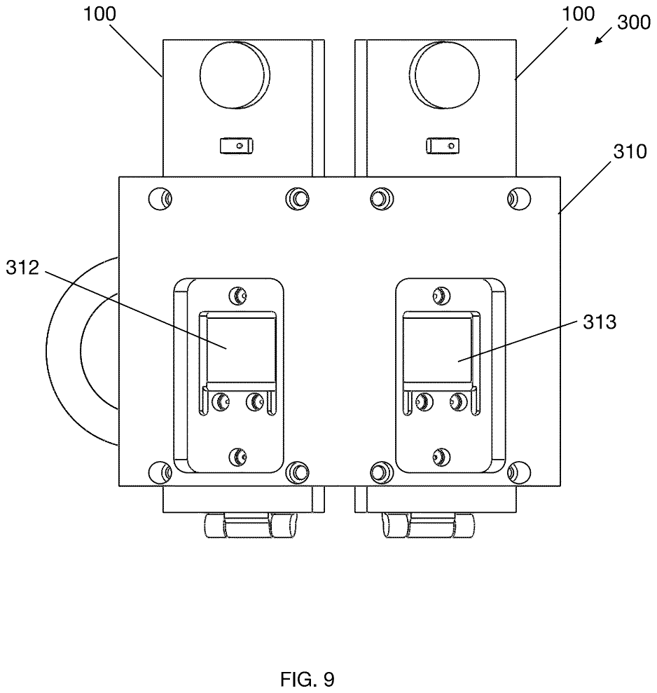

Referring to FIG. 9, a rear view of the dual-apparatus staining system shows fluid ports, ventilation structures, and temperature-control components associated with each staining apparatus.

In certain embodiments, shared cooling infrastructure, such as common cooling tubing paths (316, 317, 318), may be provided while maintaining independent thermal control elements for each staining apparatus, thereby supporting protocol-specific temperature requirements.

### Orientation and Staining Applications

In certain embodiments, the staining apparatuses and systems (100, 200, 300) may operate in a vertical or inclined orientation, for example between approximately 45 degrees and 90 degrees. Staining reagents may be delivered while the microscope slide (140) remains stationary within the staining apparatus.

In certain applications, one staining apparatus performs a first staining protocol and the other performs a different staining protocol. By way of example, one staining apparatus may perform a histochemical stain such as hematoxylin and eosin (H&E), while the other staining apparatus performs an immunohistochemical (IHC) stain, with reagents remaining fluidically isolated.

### Optical Observation and Imaging

In certain embodiments, the transparent elastic layer (121) serves as an optical window for observing or imaging the stained tissue section (141) without removing the microscope slide (140) from the staining apparatus.

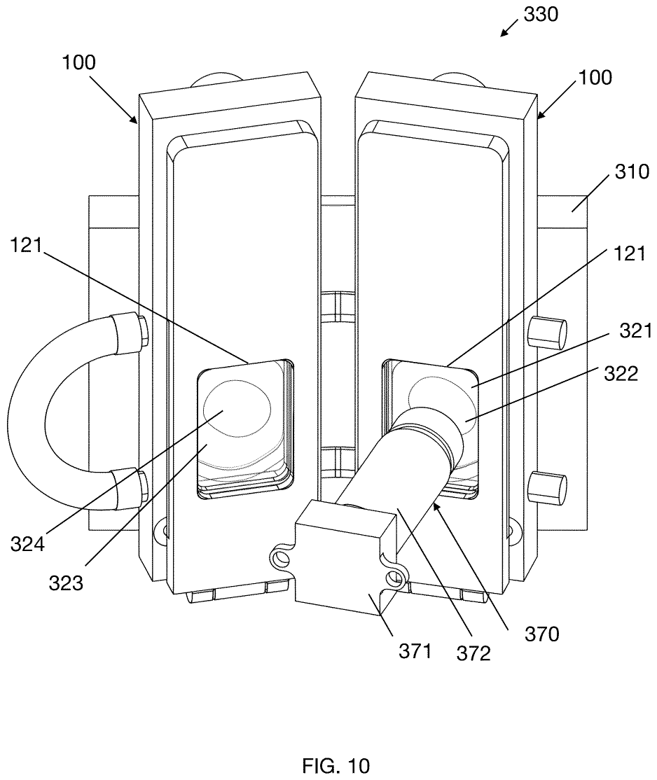

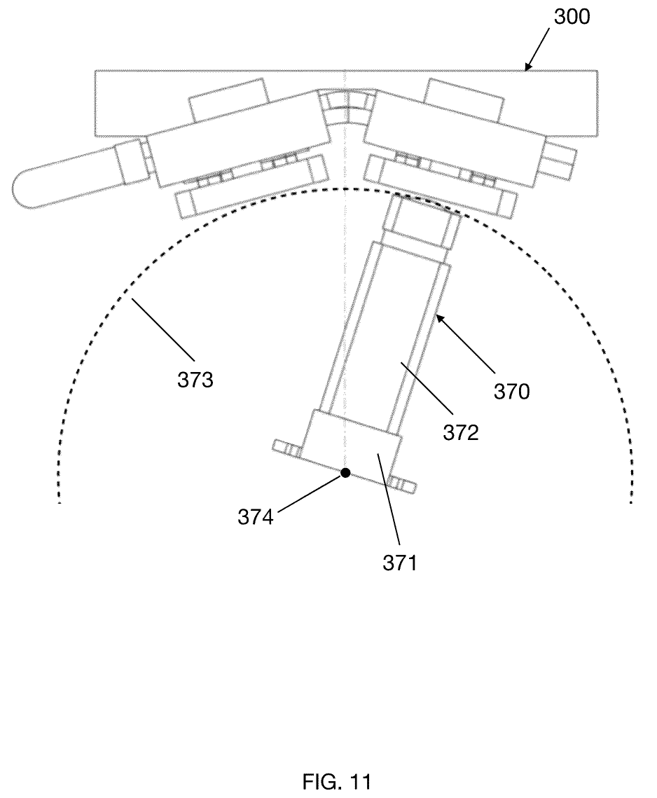

Referring to FIGS. 10 and 11, the staining system may be integrated with an imaging module (370) comprising an optical lens (372) and an image sensor (371). The imaging module may be rotatable about a central point (374) to selectively align with individual staining apparatuses arranged around the support platform.

The imaging module may rotate along a circular path (373) to sequentially capture optical images through the transparent elastic layer of each staining apparatus while the microscope slides remain in place. The angular arrangement is not limited to two staining apparatuses and may include three, four, or more staining apparatuses positioned to maintain unobstructed optical paths and repeatable alignment.

Captured image data may be stored locally, transmitted to a computing system, or provided to a local or remote reviewer for digital pathology workflows without limiting the invention to any particular analysis method.

### Scope

The apparatuses and systems described herein are suitable for a variety of staining procedures, including immunohistochemical, immunofluorescent, and histochemical staining.

While specific embodiments have been described for purposes of illustration, modifications, combinations, and alternatives may be made without departing from the spirit and scope of the invention, which is defined by the appended claims and their equivalents.

1. An apparatus for staining a tissue sample disposed on a microscope slide, comprising:
a support cartridge;
a rotatable cover mounted to the support cartridge by a hinge;
a recess formed in the support cartridge and configured to receive the microscope slide;
a sealing ring or gasket positioned on the support cartridge surrounding the recess;
wherein a surface of the support cartridge, the sealing ring, and the microscope slide cooperatively define a microfluidic reaction chamber when the rotatable cover is in a closed position;
an inlet port and a ventilation port in fluid communication with the microfluidic reaction chamber; and
a fluid delivery interface configured to introduce a staining reagent into the microfluidic reaction chamber through the inlet port.

2. The apparatus of claim 1, wherein the rotatable cover is pivotable between an open position and a closed position to permit insertion and removal of the microscope slide.

3. The apparatus of claim 1, wherein the rotatable cover applies compressive and uniform force to the microscope slide and the sealing ring through an elastic layer when the rotatable cover is secured in the closed position by an electromagnetic locking mechanism.

4. The apparatus of claim 1, wherein the inlet port is configured to both deliver staining reagents into and remove staining reagents from the microfluidic reaction chamber during a staining operation, while the microscope slide remains stationary within the apparatus.

5. The apparatus of claim 1, wherein the sealing ring is seated in a groove formed in the surface of the support cartridge, the groove defining the shape of the microfluidic reaction chamber, further wherein the microfluidic reaction chamber has a shape selected from hexagonal, round, oval, polygonal, or irregular.

6. The apparatus of claim 5, wherein the volume of the microfluidic reaction chamber is adjustable by varying the height of the sealing ring relative to the surface and is less than approximately 500 microliters.

7. The apparatus of claim 1, wherein the ventilation port is positioned at an upper region of the microfluidic reaction chamber to facilitate air displacement during reagent introduction and removal.

8. The apparatus of claim 1, wherein the apparatus comprises at least one inlet port configured to introduce staining reagents into the microfluidic reaction chamber, at least one outlet port positioned opposite the inlet port relative to the microfluidic reaction chamber and configured to remove staining reagents from the microfluidic reaction chamber, and a ventilation port positioned to facilitate air displacement during reagent introduction.

9. The apparatus of claim 8, wherein internal microfluidic channels connecting the inlet port, the outlet port, and the ventilation port have diameters in a range including approximately 0.2 mm to 2.0 mm.

10. The apparatus of claim 9, wherein the other end of the internal microfluidic channel connects to the fluid delivery interface, includes a removable connector sealed by an O-ring and a fluidic connector, further wherein the fluid delivery interface is configured to couple to an external syringe, a pump, a fluidic manifold, or a pressurized reservoir.

11. The apparatus of claim 1, further comprising at least one drain port connected to a slot to remove leaked fluid from the apparatus.

12. The apparatus of claim 1, further comprising a temperature control assembly including cooling tubings and a thermal control element embedded within the support cartridge and configured to regulate temperature within the microfluidic reaction chamber, wherein the thermal control element comprises an electrically powered heating element and a temperature sensor.

13. The apparatus of claim 1, wherein the elastic layer is transparent and mounted in the rotatable cover and serves as an optical window for direct observation or imaging of the tissue section on the microscope slide.

14. The apparatus of claim 1, wherein the apparatus is configured to operate in a vertical or inclined orientation between approximately 45 degrees and 90 degrees.

15. The apparatus of claim 1, further comprising a plurality of numerical indicators disposed on the support cartridge corresponding to respective tissue positions on the microscope slide, wherein the apparatus is configured to define a specific reagent volume to be delivered based on a selected numerical indicator.

16. A multiple-apparatus parallel staining system, comprising:
a support platform; and
a plurality of staining apparatuses according to claim 1 mounted on the support platform,
wherein each staining apparatus independently defines a corresponding microfluidic reaction chamber for parallel staining of microscope slides.

17. The system of claim 16, wherein the plurality of staining apparatuses is configured to be able to perform identical staining protocols concurrently.

18. The system of claim 16, wherein each of the staining apparatuses shares a common cooling infrastructure while maintaining independent temperature control elements.

19. The system of claim 16, wherein the plurality of staining apparatuses comprises two staining apparatuses mounted side-by-side on the support platform, the first and the second staining apparatuses include independent fluid delivery interfaces and pathways to perform different staining protocols concurrently.

20. The system of claim 19, wherein the plurality of staining apparatuses is mounted side-by-side on opposite sides of the support platform.

21. A digital pathology imaging system, comprising:
a staining apparatus according to claim 1; and
an imaging module comprising an optical lens and a camera positioned to capture images of a stained tissue sample on the microscope slide through the transparent elastic layer while the microscope slide remains secured in the staining apparatus.

22. The digital pathology imaging system of claim 21, wherein the imaging module is rotatably positioned about a central point along a circular path to selectively or sequentially image stained tissue samples from a plurality of staining apparatuses.

23. The digital pathology imaging system of claim 21, wherein multiple staining apparatuses are arranged at selected angular positions to facilitate optical alignment with the imaging module.

24. The digital pathology imaging system of claim 21, wherein optical imaging is performed without removing the microscope slide from the staining apparatus.
